(19) United States
(12) Patent Application Publication
(10) Pub. No.: US 2009/0036180 A1
(43) Pub. Date: Feb. 5, 2009

(54) ELECTRONIC DEVICE AND SLIDING MODULE THEREOF

(75) Inventor: Jun Ye, Jiangsu (CN)

Correspondence Address: QUINTERO LAW OFFICE, PC, 2210 MAIN STREET, SUITE 200, SANTA MONICA, CA, 90405, US

(73) Assignees: BENQ CO., LTD., Shanghai (CN); BENQ CORPORATION, Taipei (TW)

(21) Appl. No.: 12/175,160

(22) Filed: Jul. 17, 2008

(30) Foreign Application Priority Data
Jul. 30, 2007 (TW) TW96127723

(51) Int. Cl. H04M 1/00

(52) U.S. Cl. 455/575.4

(57) ABSTRACT

A sliding module includes a first element, a second element, and a third element disposed between the first and second elements and rotated between a first reference position and a second reference position. When the third element is located at the first reference position, the second element is positioned at a first predetermined position. When the third element is positioned at the second reference position, the second element is positioned at a second predetermined position. When the second element is moved from the first predetermined position toward a first direction, the second element pushes the third element to move from the first reference position toward the second reference position. When the second element is moved from the second predetermined position toward a second direction, the second element pushes the third element to move from the second reference position toward the first reference position.

### CROSS REFERENCE TO RELATED APPLICATIONS

This Application claims priority of Taiwan Patent Application No. 096127723, filed on Jul. 30, 2007, the entirety of which is incorporated by reference herein.

### BACKGROUND OF THE INVENTION

1. Field of the Invention

The invention relates to an electronic device, and more particularly to a mobile phone utilizing a sliding module to perform dual sliding and positioning.

2. Description of the Related Art

FIGS. 1A and 1B show a conventional sliding mobile phone D positioned in two different statuses, respectively. The sliding mobile phone D comprises a first host d1 and a second host d2 slidably connected to the first host d1, i.e., the first and second host d1 and d2 can mutually slide.

In FIG. 1A, the first and second host d1 and d2 are fully overlapped with each other. In FIG. 1B, the first and second host d1 and d2 are partially overlapped with each other. Assuming that the first host d1 is motionless, the second host d2 in FIG. 1B is relatively slid to the upper of the first host d1. However, the second host d2 is only capable of sliding along one single direction with respect to the first host d1, i.e., the second host d2 cannot be relatively slid to the lower of the first host d1.

### BRIEF SUMMARY OF THE INVENTION

The invention provides a sliding module capable of performing dual sliding. An embodiment of the sliding module comprises a first element, a second element, and a third element disposed between the first and second elements and rotated between a first reference position and a second reference position. When the third element is located at the first reference position, the second element is positioned at a first predetermined position. When the third element is positioned at the second reference position, the second element is positioned at a second predetermined position. When the second element is moved from the first predetermined position toward a first direction, the second element pushes the third element to move from the first reference position toward the second reference position. When the second element is moved from the second predetermined position toward a second direction, the second element pushes the third element to move from the second reference position toward the first reference position.

The third element is pivoted to the first element.

The second element comprises a connecting portion and the third element comprises a positioning body, a first positioning region and a second positioning region. The connecting portion of the second element contacts the first positioning region of the third element when the third element is located at the first reference position, thereby positioning the second element at the first predetermined position, and the connecting portion of the second element contacts the second positioning region of the third element when the second element moves from the second predetermined position along the second direction, thereby driving the third element to rotate from the second reference position toward the first reference position. The first and second positioning region of the third element comprises a V-shaped structure.

The sliding module further comprises an elastic device disposed between the first and second elements. The elastic device comprises torsion spring. The second element is further positioned at a third predetermined position with respect to the first element, and the relationship of the second element located at the third predetermined position and the second element located at the first predetermined position is opposite to the relationship of the second element located at the second predetermined position and the second element located at the first predetermined position.

A balanced position is provided when the third element is located between the first and second reference positions. When the second element is located between the first and second predetermined positions, the elastic device provides forces for moving the second element along the first direction. When the third element is located between the balanced position and the first reference position, the elastic device provides forces for moving the second element toward the first predetermined position.

The sliding module further comprises a recovering device disposed between the first and third elements. When the third element is located between the first and second reference positions, the recovering device causes the third element to have a balanced position. When the third element is located between the balanced position and the first reference position, the recovering device provides forces for rotating the third element toward the first reference position. When the third element is located between the balanced position and the second reference position, the recovering device provides forces for rotating the third element toward the second reference position. The recovering device can be a tension spring. The first direction is different from the second direction.

Additionally, the invention further provides an electronic device which comprises a first host, a second host and a sliding module disposed between the first and second hosts. The sliding module comprises a first element disposed on the first host, a second element disposed on the second host, and a third element disposed between the first and second elements and rotated between a first reference position and a second reference position. The second host pushed by the second element is positioned at a first predetermined position when the third element is positioned at the first reference position, and the second host pushed by the second element is positioned at a second predetermined position when the third element is positioned at the second reference position. When the second element moves from the first predetermined position along a first direction, the third element pushed by the second element is rotated from the first reference position toward the second reference position. When the second element moves from the second predetermined position along a second direction, the third element pushed by the second element is rotated from the second reference position toward the first reference position.

The electronic device is mobile phone.

Further, the invention provides an electronic device which comprises a first host, a second host and a sliding module. The sliding module is disposed between the first and second hosts.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a schematic view of a conventional sliding mobile;

FIG. 1B is a schematic view of the conventional sliding mobile in FIG. 1A positioned in another status;

FIG. 2A is a schematic view of an electronic device according to a first embodiment of the invention;

FIG. 2B is a schematic view of the electronic device in FIG. 2A positioned in another status;

FIG. 2C is a schematic view of the electronic device in FIG. 2A positioned in another status;

FIG. 3 is a schematic view of the electronic device according to an embodiment of the invention;

FIG. 4A is a perspective view of an assembled sliding module according to an embodiment of the invention;

FIG. 4B is an exploded view of the sliding module of FIG. 4A, wherein the sliding module comprises a first element, a second element, a third element, an elastic device and a recovering device;

FIG. 4C is an enlarged perspective view of the third element of FIG. 4B;

FIG. 4D is a perspective view of the first element disposed with the third element and the recovering device thereon;

FIG. 5A is a schematic view of the electronic device according to an embodiment of the invention specified by FIG. 2A;

FIG. 5B is a schematic view of the electronic device according to an embodiment of the invention specified by FIG. 2B;

FIG. 5C is a schematic view of the electronic device according to an embodiment of the invention specified by FIG. 2C;

FIG. 6A is a plane view of the sliding module of the electronic device corresponding to FIG. 5A;

FIG. 6B is a plane view of the sliding module of the electronic device corresponding to FIG. 5B;

FIG. 6C is a plane view of the sliding module of the electronic device corresponding to FIG. 5C;

FIG. 7A is a partially sectional view of the sliding module along line (c0-c0) of FIG. 6B;

FIG. 7B is a schematically instantaneous view of the second element moving along a first direction (N1) assuming that the first element of the sliding module is motionless in FIG. 7A;

FIG. 7C is another schematically instantaneous view of the second element moving along the first direction (N1) assuming that the first element of the sliding module is motionless in FIG. 7A;

FIG. 8A is a schematic view of the sliding module positioned in another status;

FIG. 8B is a schematically instantaneous view of the second element moving along a second direction (N2) assuming that the first element of the sliding module is motionless in FIG. 8A;

FIG. 8C is another schematically instantaneous view of the second element moving along the second direction (N2) assuming that the first element of the sliding module is motionless in FIG. 8A; and

FIG. 9 is a schematic view of an electronic device of a second embodiment according to the invention.

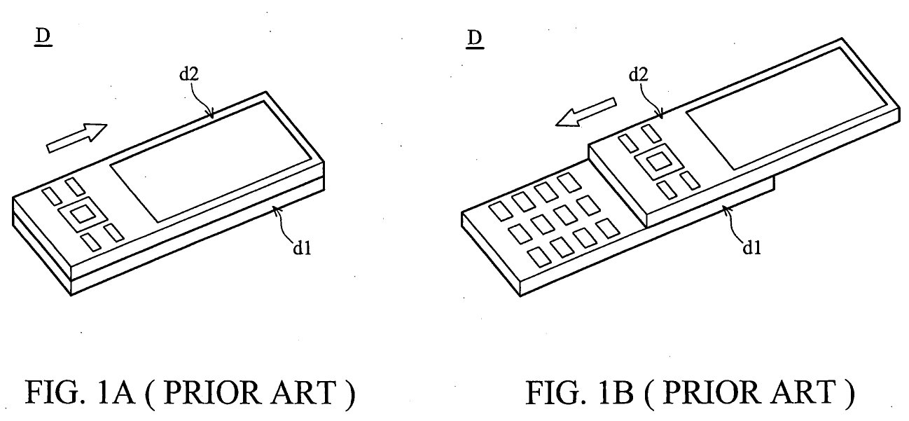

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

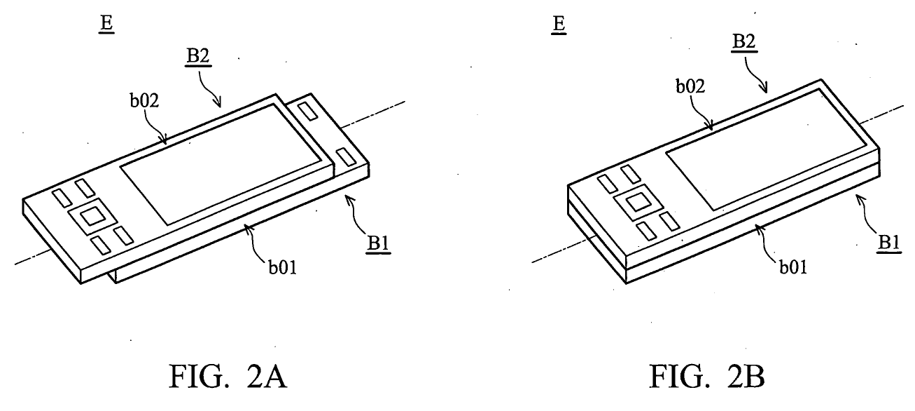

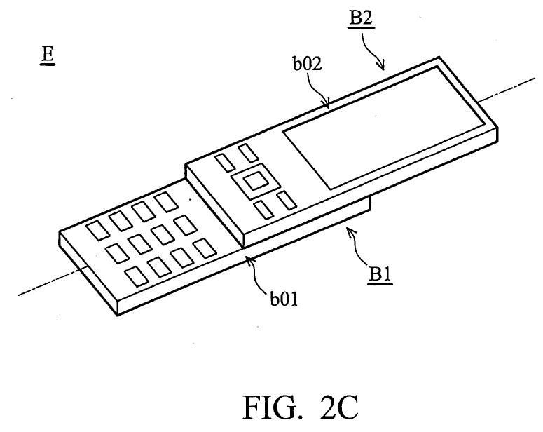

FIGS. 2A, 2B and 2C are schematic views of an electronic device E of a first embodiment positioned in three different statuses. In the embodiment, the electronic device E is mobile phone.

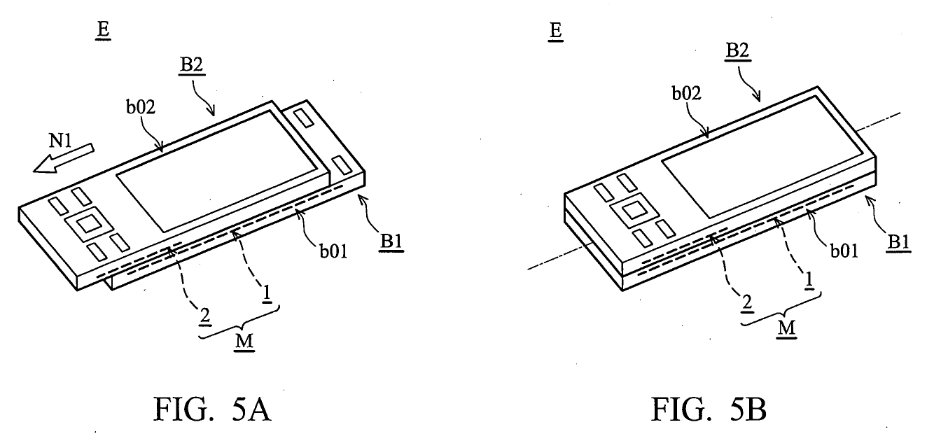

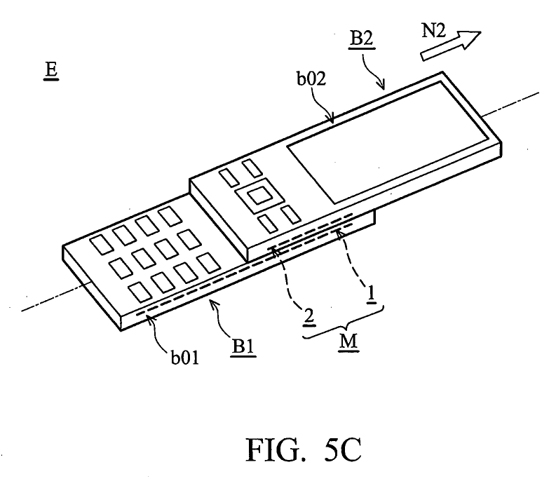

The electronic device E comprises a first host B1 having a first base b01, a second host B2 having a second base b02, and a sliding module M (marked as dotted lines in FIGS. 5A, 5B and 5C) disposed between the first base b01 of the first host B1 and the second base b02 of the second host B2. By installing the sliding module M between the first and second hosts B1 and B2, the first and second hosts B1 and B2 form a sliding pair, i.e., the first and second hosts B1 and B2 are relatively slid from each other. With respect to the motionless first host B1, the second host B2 of FIG. 2A is relatively slid to the lower of the first host B1, the second host B2 of FIG. 2B is relatively slid to the middle of the first host B1, i.e., the first and second hosts B1 and B2 are fully overlapped with each other, and the second host B2 in FIG. 2C is relatively slid to the upper of the first host B1.

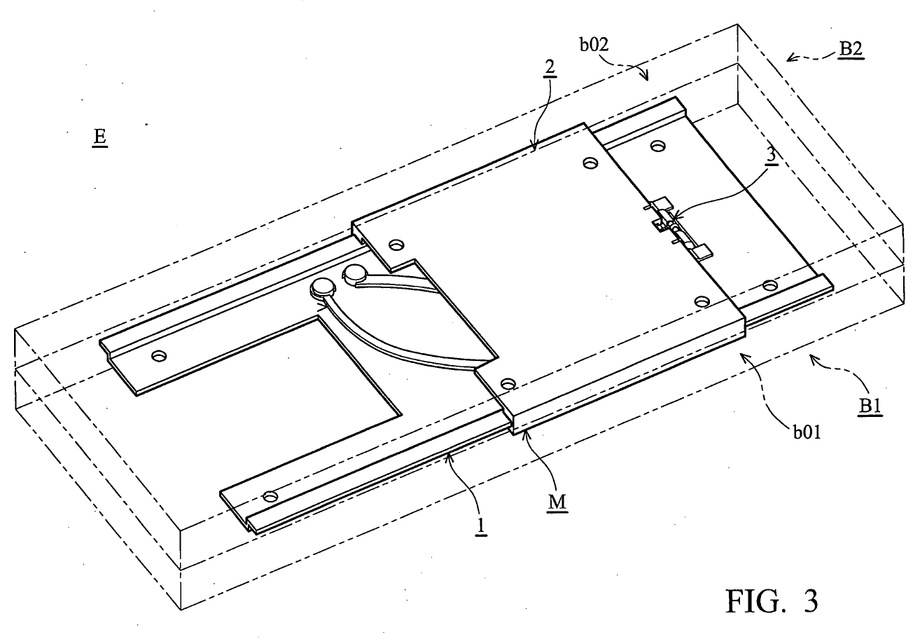

In FIG. 3, the overlapped first and second hosts B1 and B2 of the electronic device E are shown by the dotted line, and the sliding module M disposed between the first and second hosts B1 and B2 is shown by the solid line.

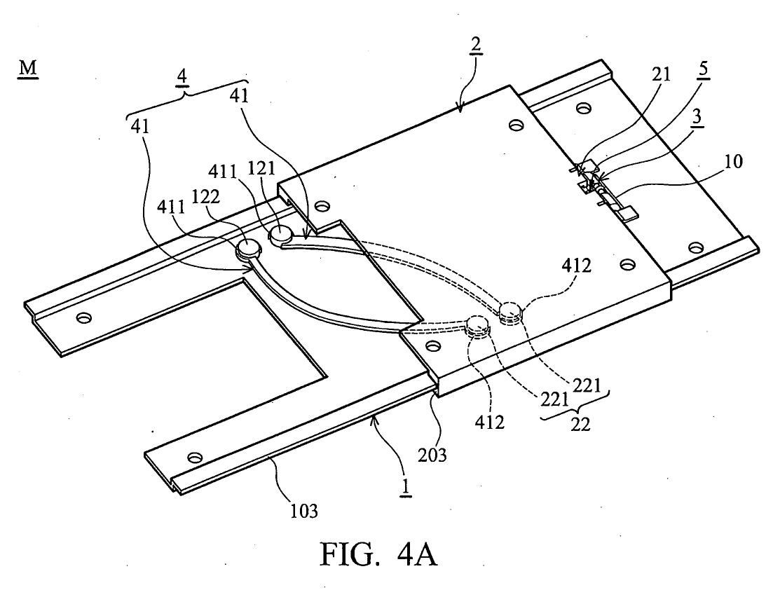

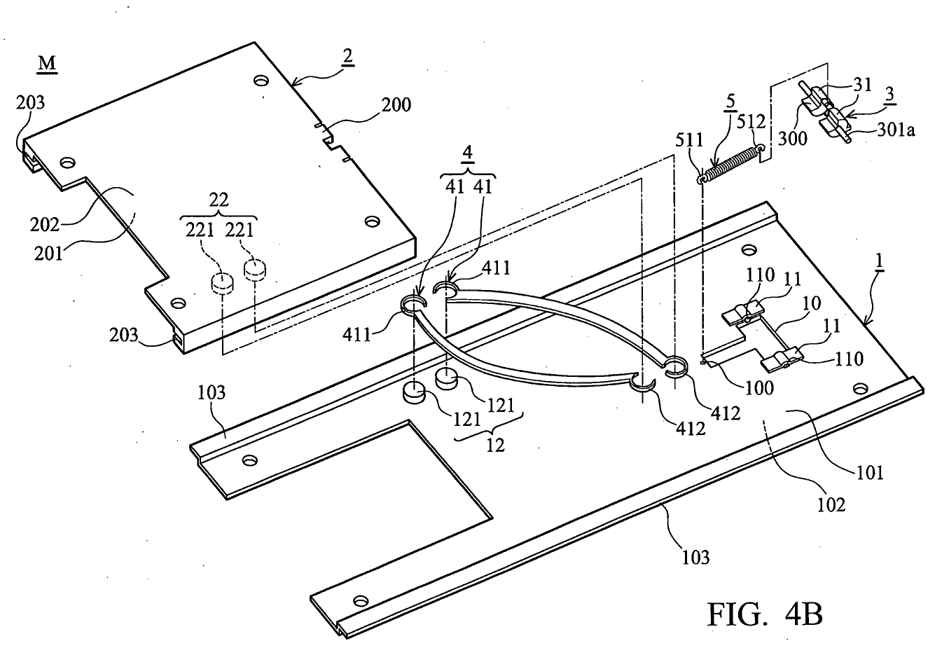

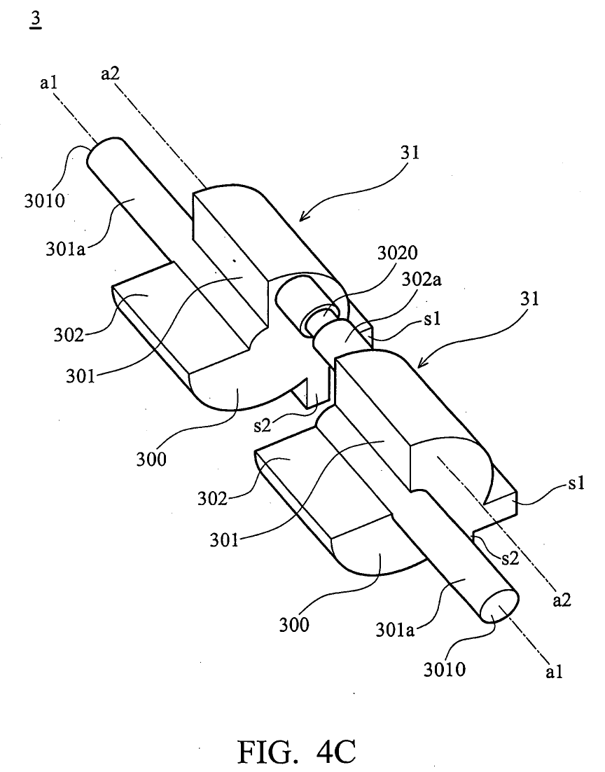

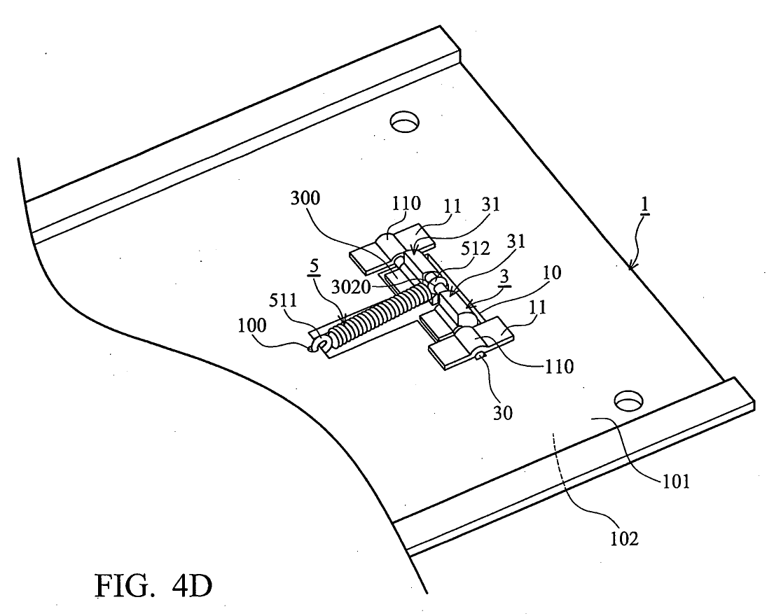

FIG. 4A is a perspective view of an assembled sliding module M, and FIG. 4B is an exploded view of the sliding module M of FIG. 4A. The sliding module M comprises a first element 1, a second element 2, a third element 3, an elastic device 4 and a recovering device 5. FIG. 4C is an enlarged perspective view of the third element 3 of FIG. 4B.

In FIGS. 4A and 4B, referring also to FIG. 3, the first element 1 of the sliding module M is disposed on the first base b01 of the first host B1, the second element 2 of the sliding module M is disposed on the second base b02 of the second host B2, and the third element 3 is disposed between the first and second elements 1 and 2. The elastic device 4 is disposed between the first and second elements 1 and 2, and the recovering device 5 is disposed between the first and third elements 1 and 3.

In FIG. 4B, the first element 1 is a rectangular plate comprising a first surface 101, a second surface 102 opposite to the first surface 101, two first side portions 103 serving as guiding rails disposed next to the first and second surfaces 101 and 102, an opening 10 formed as a T-shaped hole penetrating the first and second surfaces 101 and 102, a positioning hole 100 formed as a rounded hole penetrating the first and second surfaces 101 and 102 and disposed next to one side of the opening 10, two shaft seats 11 disposed on the first surface 101 and next to the opening 10, and a first connecting portion 12 having two spaced posts 121 protruding from the first surface 101. Each shaft seats 11 is formed with an axial hole 110.

The second element 2 is a similar rectangular plate comprising a connecting portion 200, a first surface 201, a second 202 opposite to the first surface 201, two second side portions 203 serving as guiding seats disposed next to the first and second surfaces 201 and 202, and a second connecting portion 22 having two spaced posts 221 protruding from the first surface 201. The connecting portion 200 is formed as an L-shaped hook disposed next to the first and second surfaces 201 and 202. By engaging the second side portions 203 of the second element 2 to the first side portions 103 of the first element 1, respectively, the first and second elements 1 and 2 form a sliding pair, and therefore the connecting portion 200 of the second element 2 is movably passed by the opening 10 of the first element 1.

In FIG. 4C, the third element 3 comprises two first shafts 301a, a second shaft 302a and two stopping units 31. The first shafts 301a, respectively disposed on the stopping units 31, are commonly formed along a first axis a1-a1. The second shaft 302a, disposed between the stopping units 31 and provided with an annular recess 3020, is formed along a second axis a2-a2 which substantially parallels to the first axis a1-a1.

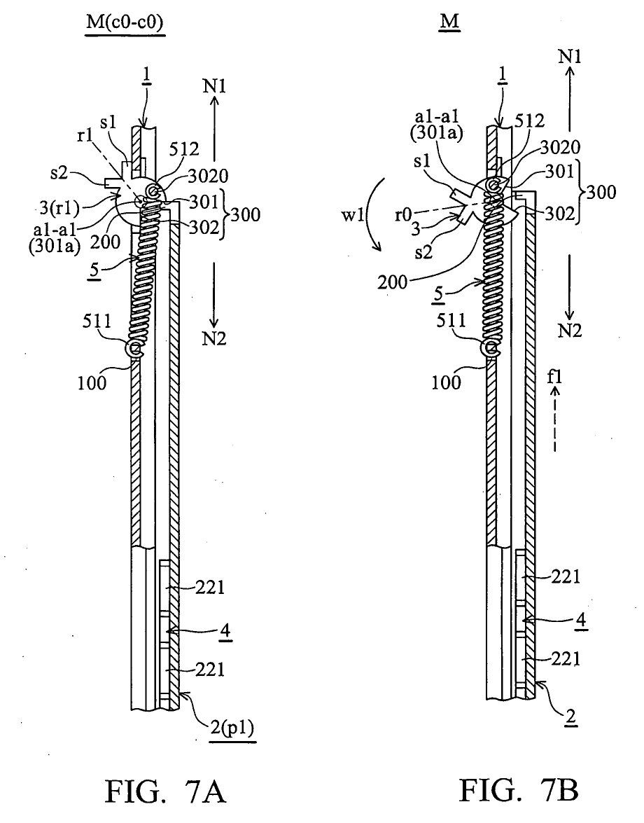

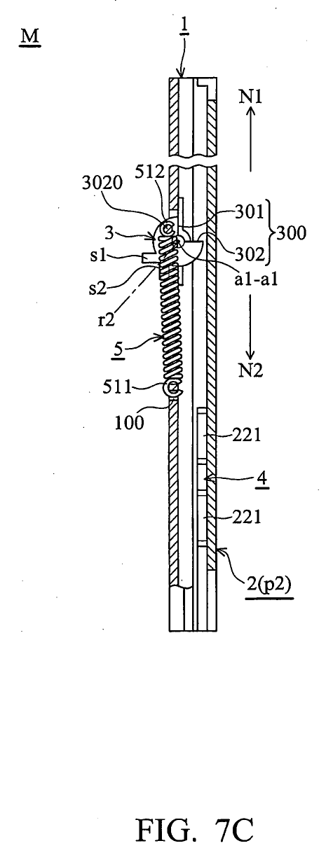

In FIG. 4C, the stopping unit 31 comprises a positioning body 300, a first positioning region 301, a second positioning region 302 disposed next to the first positioning region 301, a first stopping portion s1, and a second stopping portion s2 disposed next to the first stopping portion s1. The positioning body 300 is a post formed with a fish-like section (See FIGS. 7A and 7B). In this embodiment, the first and second positioning regions 301 and 302 are two adjacent surfaces formed on the positioning body 300, the first and second positioning region 301 and 302 of the third element 3 is formed with a V-shaped structure, the first and second stopping portions s1 and s2 are two protrusions extended from the positioning body 300 and formed with a V-shaped structure, and the ends 3010 of the first shafts 301a are respectively protruding from the sidewalls of the positioning bodies 300.

In this embodiment, the elastic device 4 comprises two torsion springs 41 having hook portions 411 and 412 at two ends thereof, and the recovering device 5 is a tension spring. By positioning the hook portions 411 and 412 of the torsion springs 41 at the posts 121 of the first connecting portion 12 and the posts 221 of the second connecting portion 22, respectively, the first and second elements 1 and 2 are connectedly assembled.

FIG. 4D is a perspective view of the first element 1 disposed with the third element 3 and the recovering device 5 thereon. In FIGS. 4C and 4D, by fitting the first shafts 301a of the third element 3 into the axial holes 110 of the shaft seats 11, the third element 3 is pivoted on the first element 1. By positioning the ends 511 and 512 to the positioning hole 100 of the first element 1 and the annular recess 3020 of the second shaft 302a of the third element 3, respectively, the recovering device 5 is disposed between the first element 1 and the third element 3. In FIG. 4D, the third element 3 pivoted on the first element 1 and connected by the recovering device 5 is maintained at an initial status. That is, the third element 3 tends to turn back to the initial status by the recovering device 5 when the third element 3 is rotated.

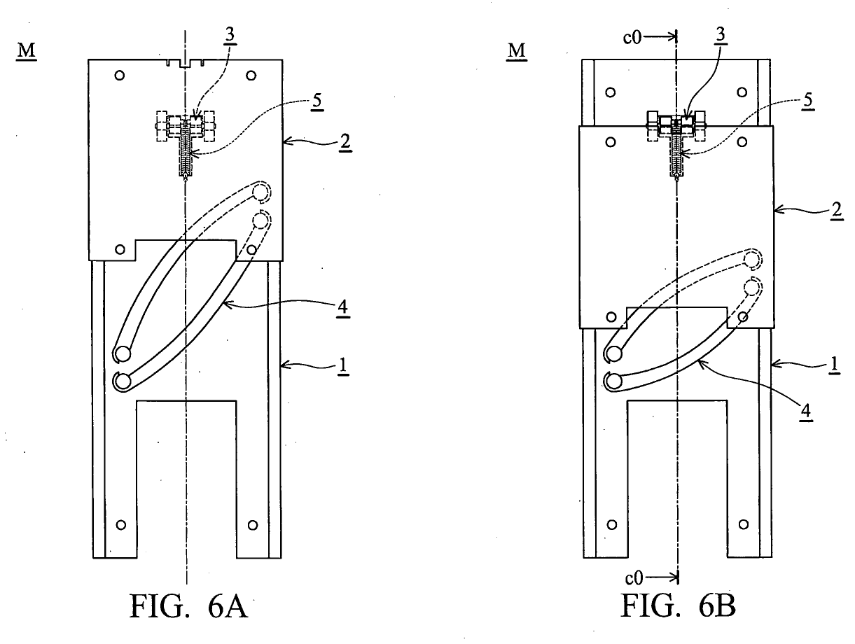

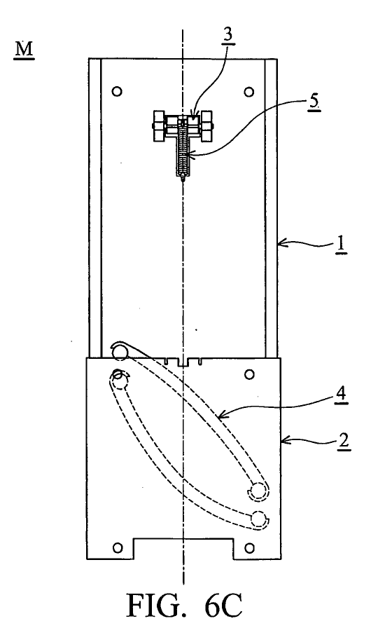

In FIGS. 5A, 5B and 5C, the electronic device E specified by FIGS. 2A, 2B and 2C are marked with two dotted lines, a longer and shorter one, to represent the corresponding positions of the first and second elements 1 and 2 situated in three different positions, respectively. FIGS. 6A, 6B and 6C are plane views of the sliding module M of the electronic device E corresponding to FIGS. 5A, 5B and 5C, respectively.

FIG. 7A is a partially sectional view of the sliding module M along line c0-c0 of FIG. 6B, FIG. 7B is a schematically instantaneous view of the second element moving along a first direction N1 assuming that the first element 1 of the sliding module M is motionless in FIG. 7A, and FIG. 7C is another schematically instantaneous view of the second element 2 moving along the first direction N1 assuming that the first element 1 of the sliding module M is motionless in FIG. 7A.

The third element 3 pivoted on the first element 1 is fully rotated or locally rotatably moved between a first reference position r1 (FIG. 7A) and a second reference position r2 (FIG. 7C).

In FIG. 7A, when the third element 3 pulled by the recovering device 5 is positioned at the first reference position r1, i.e., the first stopping portion s1 of the stopping unit 31 presses against the first element 1, and the connecting portion 200 of the second element 2 contacts the first positioning region 301 of the third element 3, the second element 2 is positioned at a first predetermined position p1, i.e., the second host B2 pushed by the second element 2 is positioned at the first predetermined position p1. Note that the positions of the ends 511 and 512 of the recovering device 5 (or of the positioning hole 100 and the annular recess 3020) and the position of the first axis a1-a1 of the first shaft 301a are substantially not located at the same plane in this situation.

In FIG. 7B, when the second element 2 of FIG. 7A is moved along the first direction N1 by an acting force f1 applied thereon, the second element 2 pushes the third element 3 pulled by the recovering device 5 to rotate along a direction w1, to separate the first stopping portion s1 of the stopping unit 31 from the first element 1. When the rotating third element 3 causes the positions of the ends 511 and 512 of the recovering device 5 (or of the positioning hole 100 and the annular recess 3020) and the position of the first axis a1-a1 of the first shaft 301a to be substantially located at the same plane, i.e., the status of FIG. 7B, the third element 3 is in a balanced state and the position thereof is defined as a balanced position r0. Note that the balanced position r0 is located between the first and second reference positions r1 and r2.

In FIG. 7C, when the rotating third element 3 passed through the balanced position r0 of FIG. 7B is positioned at the second reference position r2, i.e., the second stopping portion s2 of the stopping unit 31 presses against the first element 1, the rotation of the third element 3 is terminated, to finally position the second element 2 at a second predetermined position p2. Note that the positions of the ends 511 and 512 of the recovering device 5 (or of the positioning hole 100 and the annular recess 3020) and the position of the first axis a1-a1 of the first shaft 301a are substantially not located at the same plane.

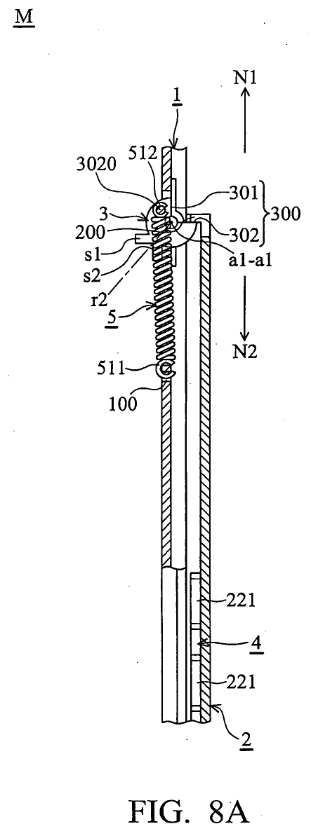

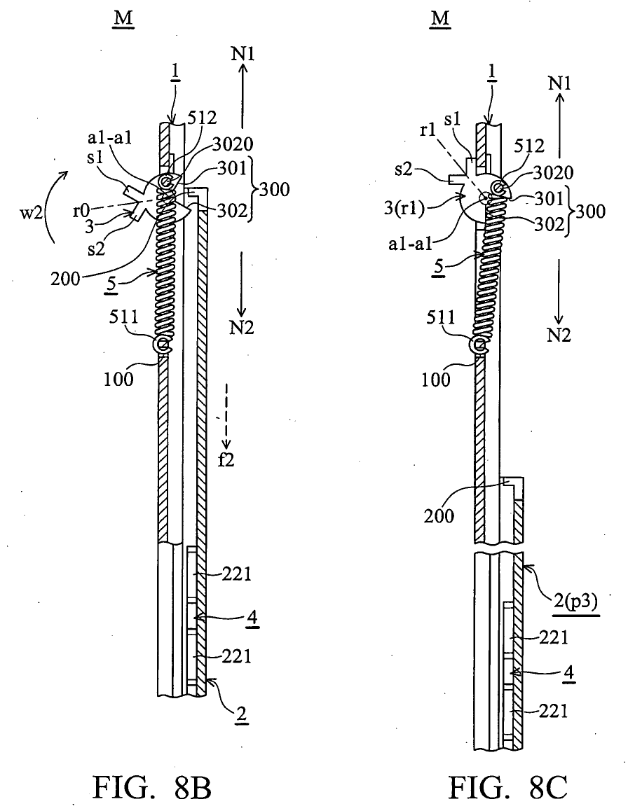

FIG. 8A is a schematic view of the sliding module M positioned in another status. FIG. 8B is a schematically instantaneous view of the second element 2 moving along a second direction N2 assuming that the first element 1 of the sliding module M is motionless in FIG. 8A. FIG. 8C is another schematically instantaneous view of the second element 2 moving along the second direction N2 assuming that the first element 1 of the sliding module M is motionless in FIG. 8A.

In FIG. 8B, when the second element 2 of FIG. 8A is moved along the first direction N2 by an acting force f2 applied thereon, the second element 2 pushes the third element 3 pulled by the recovering device 5 to rotate along a direction w2, to separate the second stopping portion s2 of the stopping unit 31 from the first element 1. When the rotating third element 3 causes the positions of the ends 511 and 512 of the recovering device 5 (or of the positioning hole 100 and the annular recess 3020) and the position of the first axis a1-a1 of the first shaft 301a to be substantially located at the same plane, i.e., the status of FIG. 8B, the third element 3 is situated at the balanced position r0.

In FIG. 8C, when the rotating third element 3 passed through the balanced position r0 of FIG. 8B is positioned at the first reference position r1, i.e., the first stopping portion s1 of the stopping unit 31 presses against the first element 1, the rotation of the third element 3 is terminated, to finally position the second element 2 at a third predetermined position p3. Referring also to FIG. 6C, the elastic device 4 provides forces for moving the second element 2 along the second direction N2 when the second element 2 is located at the third predetermined position p3. Note that the positions of the ends 511 and 512 of the recovering device 5 (or of the positioning hole 100 and the annular recess 3020) and the position of the first axis a1-a1 of the first shaft 301a are substantially not located at the same plane.

It is understood that the relationship of the second element 2 located at the third predetermined position p3 and the second element 2 located at the first predetermined position p1 is opposite to the relationship of the second element 2 located at the second predetermined position p2 and the second element 2 located at the first predetermined position p1.

When the third element 3 is located between the balanced position r0 and the first reference position r1, the recovering device 5 drives the third element 3 to rotate toward the first reference position r1, i.e., the recovering device 5 provides forces for rotating the third element 3 toward the first reference position r1. When the third element 3 is located between the balanced position r0 and the second reference position r2, the recovering device 5 drives the third element 3 to rotate toward the second reference position r2, i.e., the recovering device 5 provides forces for rotating the third element 3 toward the second reference position r2.

Further, when the second element 2 is located between the first and second predetermined positions p1 and p2, the elastic device 4 drives the second element 2 to move along the first direction N1.

When the third element 3 is located between the balanced position r0 and the first reference position r1, the elastic device 4 drives the second element 2 to move toward the first predetermined position p1. When the third element 3 is located between the balanced position r0 and the second reference position r2, the elastic device 4 drives the second element 2 to move toward the second predetermined position p2.

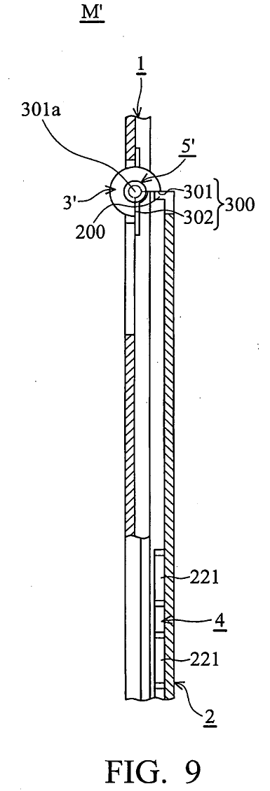

FIG. 9 is a schematic view of an electronic device M′ of a second embodiment. The electronic device M′ differs from the electronic device M in that the electronic device M′ provides a third element 3′ without the first and second stopping portions s1 and s2 of the third element 3 and a dual steady-state positioning device 5′ for replacing the recovering device 5 and the first and second stopping portions s1 and s2 of the third element 3. The dual steady-state positioning device 5′ is disposed along the first shafts 301a of the third element 3′. The same application as the dual steady-state positioning device 5′ has been disclosed by U.S. Pat. No. 5,640,690. In U.S. Pat. No. 5,640,690, a dual steady-state positioning structure is provided by a hinge assembly for hingedly connecting a cover to a housing for a mobile phone. Thus, the detailed description of the dual steady-state positioning structure is omitted herein.

Thus, dual sliding and positioning can be achieved by the disclosed sliding module M of the electronic device E.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A sliding module, comprising:
a first element;
a second element; and
a third element disposed between the first and second elements and rotated between a first reference position and a second reference position, wherein the second element is positioned at a first predetermined position when the third element is positioned at the first reference position, and the second element is positioned at a second predetermined position when the third element is positioned at the second reference position;
wherein the third element pushed by the second element is rotated from the first reference position toward the second reference position when the second element moves from the first predetermined position along a first direction, and the third element pushed by the second element is rotated from the second reference position toward the first reference position when the second element moves from the second predetermined position along a second direction.

2. The sliding module as claimed in claim 1, wherein the third element is pivoted to the first element.

3. The sliding module as claimed in claim 1, wherein the second element comprises a connecting portion and the third element comprises a positioning body, a first positioning region and a second positioning region, and the connecting portion of the second element contacts the first positioning region of the third element when the third element is located at the first reference position, thereby positioning the second element at first predetermined position, and the connecting portion of the second element contacts the second positioning region of the third element when the second element moves from the second predetermined position along the second direction, thereby driving the third element to rotate from the second reference position toward the first reference position.

4. The sliding module as claimed in claim 3, wherein the first and second positioning region of the third element comprises a V-shaped structure.

5. The sliding module as claimed in claim 1 further comprising an elastic device disposed between the first and second elements.

6. The sliding module as claimed in claim 5, wherein the elastic device comprises a torsion spring.

7. The sliding module as claimed in claim 1 further comprising an elastic device disposed between the first and second elements, wherein the elastic device drives the second element to move along the first direction when the second element is located between the first and second predetermined positions.

8. The sliding module as claimed in claim 7, wherein the elastic device comprises a torsion spring.

9. The sliding module as claimed in claim 1, wherein the second element is further positioned at a third predetermined position with respect to the first element, and the relationship of the second element located at the third predetermined position and the second element located at the first predetermined position is opposite to the relationship of the second element located at the second predetermined position and the second element located at the first predetermined position.

10. The sliding module as claimed in claim 9 further comprising an elastic device disposed between the first and second elements, wherein the elastic device provides forces for moving the second element along the second direction when the second element is located at the third predetermined position.

11. The sliding module as claimed in claim 10, wherein the elastic device comprises torsion spring.

12. The sliding module as claimed in claim 1 further comprising a recovering device disposed between the first and third elements, wherein, when the third element is located between the first and second reference positions, the recovering device causes the third element to have a balanced position, wherein the recovering device drives the third element to rotate toward the first reference position when the third element is located between the balanced position and the first reference position, and the recovering device drives the third element to rotate toward the second reference position when the third element is located between the balanced position and the second reference position.

13. The sliding module as claimed in claim 12, wherein the recovering device comprises a tension spring.

14. The sliding module as claimed in claim 1, wherein the first direction is different from the second direction.

15. The sliding module as claimed in claim 1, wherein the first direction is opposite to the second direction.

16. An electronic device, comprising:
a first host;
a second host; and
a sliding module disposed between the first and second hosts, comprising:
a first element disposed on the first host;
a second element disposed on the second host; and
a third element disposed between the first and second elements and rotated between a first reference position and a second reference position, wherein the second host pushed by the second element is positioned at a first predetermined position when the third element is positioned at the first reference position, and the second host pushed by the second element is positioned at a second predetermined position when the third element is positioned at the second reference position;
wherein the third element pushed by the second element is rotated from the first reference position toward the second reference position when the second element moves from the first predetermined position along a first direction, and the third element pushed by the second element is rotated from the second reference position toward the first reference position when the second element moves from the second predetermined position along a second direction.

17. The electronic device as claimed in claim 16 further comprising a recovering device disposed between the first and third elements, wherein, when the third element is located between the first and second reference positions, the recovering device causes the third element to have a balanced position, wherein the recovering device drives the third element to rotate toward the first reference position when the third element is located between the balanced position and the first reference position, and the recovering device drives the third element to rotate toward the second reference position when the third element is located between the balanced position and the second reference position.

18. The electronic device as claimed in claim 17, wherein the recovering device comprises a tension spring.

19. An electronic device, comprising:
a first host;
a second host; and
a sliding module according to claim 1 disposed between the first and second hosts.

20. The electronic device as claimed in claim 19, wherein the electronic device is a mobile phone.
